(19) United States
(12) Patent Application Publication
(10) Pub. No.: US 2006/0101486 A1
(43) Pub. Date: May 11, 2006

(54) System for preventing advertising removal from digital television bitstreams

(75) Inventors: Mukta Lal Kar, Superior, CO (US); Joseph W. Weber, Louisville, CO (US)

Correspondence Address: PATTON BOGGS, 1660 LINCOLN ST, SUITE 2050, DENVER, CO, 80264, US

(73) Assignee: Cable Television Laboratories, Inc., Louisville, CO (US)

(21) Appl. No.: 10/982,607

(22) Filed: Nov. 5, 2004

(51) Int. Cl. H04N 7/173; H04N 7/10

(52) U.S. Cl. 725/32; 725/118

(57) ABSTRACT

The present system for preventing the removal of advertising from digital television bitstreams detects the various advertising-specific factors, including: the time-wise predictability of advertisements, anomalies in the bitstream caused by the advertisement insertion process, and differences in the characteristics of advertisements versus the digital media content, then eliminates these characteristics from the digital media content bitstream. By eliminating the advertising-specific characteristics, there are no identifiable discontinuities in the digital media content bitstream that can be used to locate advertisements and therefore enable their removal from the digital media content bitstream.

### FIELD OF THE INVENTION

This invention relates to the field of broadcast television and devices that locate and remove advertisements from digital television bitstreams.

### PROBLEM

It is a problem in the field of broadcast television to prevent subscribers from employing devices that locate and remove advertisements from digital television bitstreams. Digital television bitstreams in the MPEG-2 and other data formats contain audio-visual programming that includes advertisements. The location of these advertisements in the bitstream can be determined based on a number of factors, including: the time-wise predictability of advertisements, anomalies in the bitstream caused by the advertisement insertion process such as changes in bitrate or resolution, and differences in the characteristics of advertisements versus the digital media content.

There are existing systems that consumers use to monitor the digital television bitstream and search for the above-noted factors which identify the presence of an advertisement in the digital television bitstream. Once the advertisement is detected, it is excised from the digital television bitstream. This process is commonly used in systems that are used to record the program content contained in the digital television bitstream. Elimination of advertisements reduces the amount of memory required to store the digital television bitstream and also provides uninterrupted program content in the recorded program. However, the expunging of advertisements from the digital television bitstream reduces the advertisement value of the digital television bitstream to the advertiser, since the audience reached by the advertisements is reduced in size.

Thus, there is a need for a system that blocks the devices that locate and remove advertisements from digital television bitstreams.

### SOLUTION

The above-described problems are solved and a technical advance achieved by the present system for preventing advertising removal from digital television bitstreams. This system detects the various advertising-specific factors, including: the time-wise predictability of advertisements, anomalies in the bitstream caused by the advertisement insertion process such as changes in bitrate or resolution, and differences in the characteristics of advertisements versus the digital media content, then eliminates these characteristics from the digital media content bitstream. By eliminating the advertising-specific characteristics, there are no identifiable discontinuities in the digital media content bitstream that can be used to locate advertisements and therefore enable their removal from the digital media content bitstream.

### BRIEF DESCRIPTION OF THE DRAWINGS

FIG. 1 illustrates in block diagram form the overall architecture of a system that splices advertisements into a bitstream of digital media content; and

FIG. 2 illustrates in flow diagram for the operation of the present system for preventing advertising removal from digital television bitstreams.

### DETAILED DESCRIPTION

Digital television bitstreams in the MPEG-2 and other data formats contain audio-visual programming that includes advertisements. Typically, digital audiovisual content is created separately from the digital advertisements. These two separate bitstreams are merged before transmission. Standards such as ANSI/SCTE 35 and ANSI/SCTE 30 define specific data indicators in the original bitstream to indicate where the advertisements can be inserted. These indicators can be used to identify the location of the advertisement and facilitate the removal of the advertisement from the bitstream. Removal of these indicators after the two bitstreams have been merged prevents this technique from being effective.

For example, ANSI/SCTE 35 defines Splice Points in an MPEG-2 transport stream as a means of providing opportunities to switch elementary streams from one source to another. The Splice Points indicate a place to switch elementary streams or a place in the bit stream where such a switch can be made. Transport streams are created by multiplexing packet identifier (PID) streams, which are all of the packets having the same packet identifier (PID) within a transport stream. The ANSI/SCTE 35 standard defines two types of Splice Points for PID streams: Out Points and In Points. In Points are places in the bit stream where it is acceptable to enter from a splicing standpoint. Out Points are places where it is acceptable to exit the bit stream. Out Points and In Points are imaginary points in the bitstream that are located between two elementary stream presentation units. Out Points and In Points may apply to program streams as well as elementary streams.

Architecture of an Advertising Insertion System

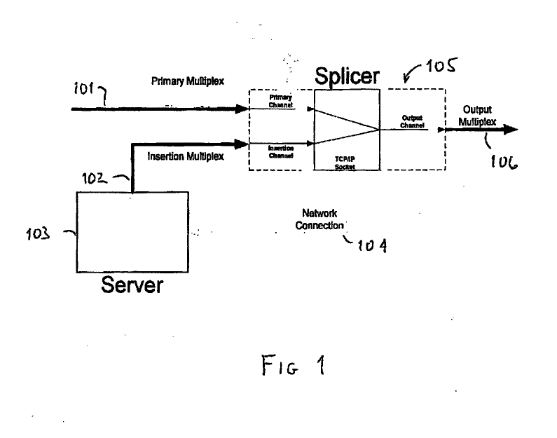

FIG. 1 illustrates a typical system block diagram for a configuration of an advertising insertion system as presently used in existing network configurations. The advertising insertion system consists of an Advertisement Insertion Server 103 and a Signal Splicer 105. The advertisement insertion system receives a Primary Multiplex Signal 101 which consists of the transport stream, typically the digital media content from a program source (not shown). The Advertisement Insertion Server 103 is connected to a source of advertisements (not shown) and/or has a series of advertisements stored in memory therein. The Advertisement Insertion Server 103 functions to manage the interleaving of advertisements with digital media content that is received from a program source.

The location of advertisement insertion is typically managed by program advertising staff, which identifies the advertisement as well as the advertisement insertion points in the digital media content bitstream, pursuant to the standards articulated in the above-noted ANSI/SCTE 35 and ANSI/SCTE 30 standards.

In operation, the Advertisement Insertion Server 103 transmits an Insertion Multiplex Signal 102 consisting of advertisements to the Splicer 105, where the Insertion Multiplex Signal 102 is merged with the Primary Multiplex Signal 101. A network channel 104 is used to interconnect the Splicer 105 to the Advertisement Insertion Server 103 to enable control signals to be exchanged there between. The control signals identify the advertisement insertion points and are coordinated with the presence of the advertisement in the associated Insertion Multiplex Signal 102.

The Splicer 105 responds to the control signals by switching the elementary streams that are routed to the output of the Splicer 105. The output from the Splicer 105 is a single transport stream 106 comprising the combination of the two multiplex streams that are input to the Splicer 105. Logically, a splice involves two input channels 101, 102 and one output channel 106. The Splicer 105 is responsible for joining the various elementary streams (audio, video, and data) together. Typically, the communication between the Advertisement Insertion Server 103 and the Splicer 105 is conducted over one TCP/IP socket connection per output channel. The input channels 101, 102 and 103 may be communicated over TCP/IP as well.

Operation of the System for Preventing Advertising Removal

As part of the content splicing process, inserting advertisements into content bitstreams introduces any of a number of factors, including: the time-wise predictability of advertisements, anomalies in the bitstream caused by the advertisement insertion process, such as changes in bitrate or resolution, and differences in the characteristics of advertisements versus the digital media content. The present system for preventing advertising removal from digital television bitstreams detects the various advertising-specific factors, then eliminates these characteristics from the digital media content bitstream. By eliminating the advertising-specific characteristics, there are no identifiable discontinuities in the digital media content bitstream that can be used to locate advertisements and therefore enable their removal from the digital media content bitstream.

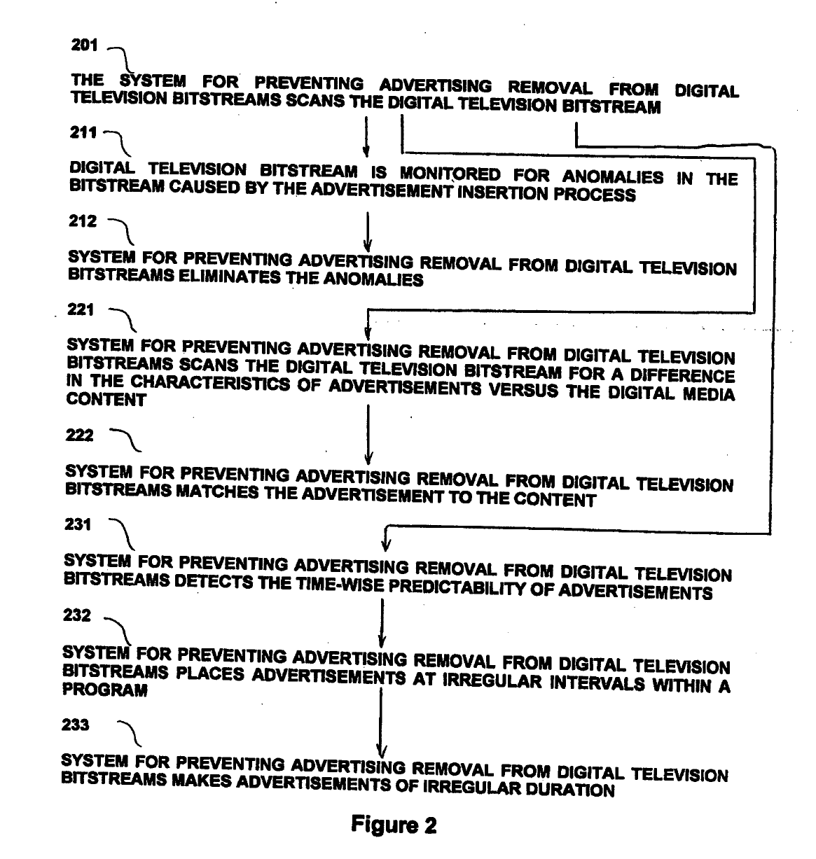

FIG. 2 illustrates in flow diagram the operation of the present system for preventing advertising removal from digital television bitstreams. The process is initiated at step 201 and scans the digital television bitstream created by the Splicer 105 to detect anomalies in the bitstream caused by the advertisement insertion process at step 211, where these anomalies typically comprise aural or visual signatures at the transitions between content and advertisement. One visual signature is the addition of a significant number of black frames at the transitions. The reduction or even elimination of these black frames at the transitions nullifies the use of this technique to locate advertisements. Another signature is the muting of the audio during transitions. Another is a distinct difference in the encoding bitrate between the content and the advertisement. Another is a change in pixel resolution, aspect ratio or other screen format value. If one of these anomalies is detected, at step 212, the system for preventing advertising removal from digital television bitstreams eliminates the black frames, the muting of audio during transitions, any difference in the encoding bitrate between the content and the advertisement, and any change in pixel resolution, aspect ratio or other screen format value.

At step 221, the system for preventing advertising removal from digital television bitstreams detects a difference in the characteristics of advertisements versus the digital media content. One such difference is that the audio level changes during advertisements, such as the advertisement being louder than that of the digital program content. If the system for preventing advertising removal from digital television bitstreams detects a difference, then the audio level of the advertisements is matched to the content using digital technology at step 222.

At step 231, the system for preventing advertising removal from digital television bitstreams detects the time-wise predictability of advertisements which represents a major advertisement identifier, since advertisements and non-program content information is typically present in a predictable manner at the hour and half hour, with additional insertions typically happening at predetermined times between these benchmark times, at ten or fifteen minute intervals. To overcome this predictability, at step 232, the advertisements are placed at irregular intervals within a program to make it more difficult to locate them. In addition, at step 233, advertisements can be made of irregular duration, rather than the present consistent and uniform duration.

### SUMMARY

The present system for preventing advertising removal from digital television bitstreams detects the various advertising-specific factors, including: the time-wise predictability of advertisements, anomalies in the bitstream caused by the advertisement insertion process, and differences in the characteristics of advertisements versus the digital media content, then eliminates these characteristics from the digital media content bitstream.

What is claimed:

1. A system for preventing advertising removal from digital television bitstreams which comprise advertisements merged into a digital media content bitstream, which digital television bitstreams are transmitted from a broadcast television system to consumer devices, said system for preventing advertising removal comprising:
means for detecting at least one advertising-specific characteristic that identifies a presence of an advertisement in said digital television bitstream that is transmitted from said broadcast television system to consumer devices; and
means for expunging at least one said advertising-specific characteristic.

2. The system for preventing advertising removal from digital television bitstreams of claim 1 wherein said means for detecting at least one advertising-specific characteristic comprises:
means for detecting an anomaly in said digital television bitstream caused by the advertisement insertion process.

3. The system for preventing advertising removal from digital television bitstreams of claim 1 wherein said means for detecting at least one advertising-specific characteristic comprises:
means for detecting differences in the bitrate of digital streams advertisements versus the digital media content.

4. The system for preventing advertising removal from digital television bitstreams of claim 3 wherein said means for expunging said at least one advertising-specific characteristic comprises:
means, responsive to a presence of at least one advertising-specific characteristic comprising a change in bitrate at the transitions, for eliminating the change in bitrate during transitions.

5. The system for preventing advertising removal from digital television bitstreams of claim 1 wherein said means for detecting at least one advertising-specific characteristic comprises:
means for detecting differences in the screen resolution of advertisements versus the digital media content.

6. The system for preventing advertising removal from digital television bitstreams of claim 5 wherein said means for expunging said at least one advertising-specific characteristic comprises:
means, responsive to a presence of at least one advertising-specific characteristic comprising a change in screen resolution at the transitions, for eliminating the change in screen resolution during transitions.

7. The system for preventing advertising removal from digital television bitstreams of claim 1 wherein said means for detecting at least one advertising-specific characteristic comprises:
means for detecting differences in the aspect ratio of digital streams advertisements versus the digital media content.

8. The system for preventing advertising removal from digital television bitstreams of claim 7 wherein said means for expunging said at least one advertising-specific characteristic comprises:
means, responsive to a presence of at least one advertising-specific characteristic comprising a change in aspect ratio at the transitions, for eliminating the change in aspect ratio during transitions.

9. The system for preventing advertising removal from digital television bitstreams of claim 1 wherein said means for detecting at least one advertising-specific characteristic comprises:
means for detecting aural or visual signatures at the transitions between content and advertisement.

10. The system for preventing advertising removal from digital television bitstreams of claim 9 wherein said means for expunging said at least one advertising-specific characteristic comprises:
means, responsive to a presence of at least one aural or visual signature comprising a significant number of black frames at the transitions and the muting of the audio during transitions, for eliminating the black frames and muting of audio during transitions.

11. The system for preventing advertising removal from digital television bitstreams of claim 1 wherein said means for detecting at least one advertising-specific characteristic comprises:
means for detecting differences in the characteristics of advertisements versus the digital media content.

12. The system for preventing advertising removal from digital television bitstreams of claim 11 wherein said means for expunging at least one said advertising-specific characteristic comprises:
means, responsive to a presence of increased audio volume during an advertisement, for reducing said audio volume of said advertisement to correspond to an audio volume of said digital program content.

13. The system for preventing advertising removal from digital television bitstreams of claim 1, further comprising:
means for detecting time-wise predictability of advertisements.

14. The system for preventing advertising removal from digital television bitstreams of claim 13 wherein said means for expunging at least one said advertising-specific characteristic comprises:
means for randomizing the time at which said advertisements are merged into said digital media content bitstream.

15. A method for preventing advertising removal from digital television bitstreams which comprise advertisements merged into a digital media content bitstream, which digital television bitstreams are transmitted from a broadcast television system to consumer devices, said system for preventing advertising removal comprising:
detecting at least one advertising-specific characteristic that identifies the presence of an advertisement in said digital television bitstream that is transmitted from said broadcast television system to consumer devices; and
expunging at least one said advertising-specific characteristic.

16. The method for preventing advertising removal from digital television bitstreams of claim 15 wherein said step of detecting at least one advertising-specific characteristic comprises:
detecting an anomaly in said digital television bitstream caused by the advertisement insertion process.

17. The method for preventing advertising removal from digital television bitstreams of claim 15 wherein said step of detecting at least one advertising-specific characteristic comprises:
detecting differences in the bitrate of digital streams advertisements versus the digital media content.

18. The method for preventing advertising removal from digital television bitstreams of claim 17 wherein said step of expunging said at least one advertising-specific characteristic comprises:
eliminating, in response to a presence of at least one advertising-specific characteristic comprising a change in bitrate at the transitions, the change in bitrate during transitions.

19. The method for preventing advertising removal from digital television bitstreams of claim 15 wherein said step of detecting at least one advertising-specific characteristic comprises:
detecting differences in the screen resolution of advertisements versus the digital media content.

20. The method for preventing advertising removal from digital television bitstreams of claim 19 wherein said step of expunging said at least one advertising-specific characteristic comprises:
eliminating, in response to a presence of at least one advertising-specific characteristic comprising a change in screen resolution at the transitions, the change in screen resolution during transitions.

21. The method for preventing advertising removal from digital television bitstreams of claim 15 wherein said step of detecting at least one advertising-specific characteristic comprises:
detecting differences in the aspect ratio of digital streams advertisements versus the digital media content.

22. The method for preventing advertising removal from digital television bitstreams of claim 21 wherein said step of expunging said at least one advertising-specific characteristic comprises:
eliminating, in response to a presence of at least one advertising-specific characteristic comprising a change in aspect ratio at the transitions, the change in aspect ratio during transitions.

23. The method for preventing advertising removal from digital television bitstreams of claim 15 wherein said step of detecting at least one advertising-specific characteristic comprises:
detecting aural or visual signatures at the transitions between content and advertisement.

24. The method for preventing advertising removal from digital television bitstreams of claim 23 wherein said step of expunging said at least one advertising-specific characteristic comprises:
eliminating, in response to a presence of at least one aural or visual signature comprising a significant number of black frames at the transitions and the muting of the audio during transitions, the black frames and muting of audio during transitions.

25. The method for preventing advertising removal from digital television bitstreams of claim 15 wherein said step of detecting at least one advertising-specific characteristic comprises:
detecting differences in the characteristics of advertisements versus the digital media content.

26. The method for preventing advertising removal from digital television bitstreams of claim 25 wherein said step of expunging at least one said advertising-specific characteristic comprises:
reducing, in response to a presence of increased audio volume during an advertisement, said audio volume of said advertisement to correspond to an audio volume of said digital program content.

27. The method for preventing advertising removal from digital television bitstreams of claim 15, further comprising:
detecting time-wise predictability of advertisements.

28. The method for preventing advertising removal from digital television bitstreams of claim 27 wherein said step of expunging at least one said advertising-specific characteristic comprises:
randomizing the time at which said advertisements are merged into said digital media content bitstream.
